(19) United States
(12) Patent Application Publication
(10) Pub. No.: US 2022/0148045 A1
(43) Pub. Date: May 12, 2022

(54) AUTOMATED APPRAISAL ASSESSMENT

(71) Applicant: ACCURATE GROUP HOLDINGS, LLC, Independence, OH (US)

(72) Inventor: Scott WAXMAN, Highland Park, IL (US)

(21) Appl. No.: 17/096,451

(22) Filed: Nov. 12, 2020

(51) Int. Cl. G06Q 30/02; G06Q 50/16; G06Q 10/10; G06F 16/93; G06F 40/18

(52) U.S. Cl. CPC G06Q 30/0278; G06Q 50/16; G06F 40/18; G06F 16/93; G06Q 10/10

(57) ABSTRACT

One or more techniques and/or systems are provided for automated appraisal assessment. A property appraisal metric pertaining to a subject property is identified within a spreadsheet. The spreadsheet is evaluated to identify one or more additional property appraisal metrics pertaining to one or more comparable properties. The one or more additional property appraisal metrics are compared to the subject property with threshold variances/deviations identified. When threshold variances/deviations are not met, a message comprising a suggested adjustment value derived from the comparison of the average comparable property appraisal metric and the property appraisal metric is displayed and/or a modification is applied to a cell within which the property appraisal metric is populated.

### BACKGROUND

Real estate appraisal is a time consuming and expensive process. Real estate appraisal involves significant manual efforts by an appraiser, such as visiting a subject property to be appraised, identifying comparable properties that are similar to the subject property, and comparing property appraisal metrics (e.g., square footage, bedroom count, bathroom count, age, etc.) between the subject property and the comparable properties in order to assign individual numerical adjustments in order to estimate an appraised value to the subject property. Because human appraisers are comparing the property appraisal metrics in order to assign the appraised value to the subject property (e.g., increase the appraised value compared to a comparable value if the subject property has larger square footage, decrease the appraised value compared to a comparable value if the subject property has fewer bathrooms, etc.), the resulting appraised value is subjective. Manual analysis of comparable properties (“comparables”) is time consuming and in many instances unproductive. Standard methods for analyzing comparables involve use of adjustment grids with appraiser generated numerical adjustments.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more computer implemented systems and/or techniques for automated appraisal assessment utilizing a smart electronic spreadsheet are provided herein. A computing device may store a spreadsheet, such as a smart electronic spreadsheet, within storage of the computing device, and may display the smart electronic spreadsheet on a display of the computing device utilizing a spreadsheet computer program executing on the computing device. The smart electronic spreadsheet may be populated with data from various sources, such as information input by a user through an input device of the computing device, information extracted from a remote data source over a network (e.g., automated data retrieval and automatic population of the retrieved data into the smart electronic spreadsheet, such as retrieval of information relating to identified suitable comparable properties from a remote computer hosting a real estate listing service), etc. The data may be populated within cells of the smart electronic spreadsheet. The data may correspond to property appraisal metrics associated with a subject property to be appraised, and property appraisal metrics associated with one or more comparable properties used to appraise the subject property. The property appraisal metrics may comprise information related to the subject property and the comparable properties, such as an address, locational information, sale price, list price, sale date, sale type, market condition, view, design/style, quality of construction, property type (e.g., condo, house, etc.), age, condition, living area, room count, gross living area, basement square footage, basement finished square footage, rooms below grade, heating/cooling type, garage/parking, amenities, porch/deck/patio, etc.

In some embodiments, each cell or groupings of cells pertaining to the same type of property appraisal metric (e.g., a first cell populated with a gross living area for the subject property, a second cell populated with a gross living area for a first comparable property, a third cell populated with a gross living area for a second comparable property, etc.) may be associated with a formula that can be executed by the spreadsheet computer program utilizing computing resources of the computing device. In an example, the formula may be embedded within a cell or grouping of cells. The formula of the cell may be executed by the spreadsheet computer program in order to evaluate information within the cell and/or other cells, such as to identify adjustments to make to a value of the subject property (e.g., when a deviation exceeds one or more deviation thresholds/variances) and/or to generate an alert when the evaluation of the information and/or the information itself indicates that additional review and/or analysis by a user is required. For example, a formula may be associated with the first cell comprising the gross living area for the subject property. The formula may be executed to compare the gross living area for the subject property within the first cell against at least one of the gross living area for the first comparable property within the second cell, the gross living area for the second comparable property within the third cell, and/or other gross living areas of other comparable properties. The formula may compare the gross living area values (e.g., compare the gross living area for the subject property to an average of the gross living areas of the comparable properties) in order to calculate a deviation between the gross living area for the subject property and the gross living areas for the comparable properties, such as by utilizing linear regression or any other formula.

The spreadsheet computer program may execute various functionality based upon the deviation. In an example, a message may be displayed to describe the deviation. The message may indicate that even though there is a differential/deviation, manual adjustment is not needed due to certain calculated deviations being met (e.g., certain deviation thresholds/variances not being exceeded). The message may indicate that a user should perform manual adjustment for the appraisal value of the subject property to take into account the deviation, such as whether the gross living area for the subject property deviates more than a threshold amount from a gross living area for a comparable property. The message may comprise a suggested adjustment value to apply to the appraisal value of the subject property to take into account the deviation (e.g., a dollar amount to increase the appraisal value based upon how much larger is the gross living area for the subject property than the gross living area for the comparable property). The message may indicate that the user can utilize a simple average in relation to the gross living areas for the comparable properties for determining the appraisal value in terms of gross living area because the deviation is below a threshold amount. In another example, a display property of a cell (e.g., a background color, font, text color, size, etc.) may be modified based upon whether the deviation exceeds one or more deviation thresholds. For example, if the deviation is below a first threshold, then a first background color may be applied to the cell (e.g., green to indicate that no additional manual intervention or adjustments are necessary because the deviation is low, and thus the gross living areas are similar). If the deviation is between the first threshold and a second threshold, then a second background color may be applied to the cell (e.g., yellow). If the deviation is greater than the second threshold, then a third background color may be applied to the cell (e.g., red to indicate that the appraisal value could be incorrect if the deviation is not taken into account).

In another example, the message may comprise a suggested appraisal value for the subject property. The suggested appraisal value may be determined based upon the spreadsheet computer program executing the formulas within the cells to determine adjustment values for property appraisal metrics used to appraise the subject property. The adjustment values for each of the property appraisal metrics may be utilized to derive the suggested appraisal value. In an example, different formulas and/or different deviation thresholds may be specified for different types of property appraisal metrics, and thus the suggested appraisal value may be tailored for utilizing adjustment values that are derived from various formulas and/or deviations thresholds that are appreciated for particular types of property appraisal metrics. The suggested appraisal value and/or the adjustment values may be suggested to a user, or may be automatically applied by the spreadsheet computer program to the smart electronic spreadsheet to output a more accurate and/or objective final appraisal value for the subject property. In this way, an evaluation is performed by taking comparable properties, averaging values of property appraisal metrics of the comparable properties, and determining and/or automatically implementing adjustments based upon a comparison of the average values to values of property appraisal metrics of the subject property.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an example method of automated appraisal assessment utilizing a smart electronic spreadsheet, where properties of one or more cells are modified.

FIG. 2 is a component block diagram illustrating an example system for automated appraisal assessment utilizing a smart electronic spreadsheet, where properties of one or more cells are modified.

FIG. 3 is a flow diagram illustrating an example method of automated appraisal assessment utilizing a smart electronic spreadsheet, where a message is displayed.

FIG. 4 is a component block diagram illustrating an example system for automated appraisal assessment utilizing a smart electronic spreadsheet, where a message is displayed.

FIG. 5 is a flow diagram illustrating an example method of automated appraisal assessment utilizing a smart electronic spreadsheet, where a message is displayed.

FIG. 6 is a component block diagram illustrating an example system for automated appraisal assessment utilizing a smart electronic spreadsheet, where a message is displayed.

FIG. 7 is an illustration of an example computer readable medium wherein processor-executable instructions configured to embody one or more of the provisions set forth herein may be comprised.

FIG. 8 illustrates an example computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more systems and/or techniques for automated appraisal assessment utilizing a smart electronic spreadsheet are provided herein. Current real estate appraisal processes require a significant amount of manual effort by an appraiser, which can lead to increased preparation time as well as unnecessary effort in determining when adjustments are necessary. Subjectivity occurs due to the imprecise nature of determining if and how much of an adjustment is necessary to a comparable property. Efficiencies can be achieved if the appraiser can identify appropriate comparable properties (“comparables”) and average unadjusted values to develop an opinion of a value for a subject property. In order to achieve these efficiencies, a method should be able to identify circumstances in which the method is unable to return reliable values without a more detailed analysis of comparables, and thus the appraiser should be alerted that additional review and/or analysis is required. This is achieved with computer based smart spreadsheets which can identity when the average price must be adjusted and also suggest how much that adjustment should be.

Accordingly, as provided herein, automated appraisal assessment is implemented for a smart electronic spreadsheet. A spreadsheet computer program executing on a computing device may utilize computing resources of the computing device to implement the automated appraisal assessment upon the smart electronic spreadsheet. This automated appraisal assessment and smart electronic spreadsheet improves the appraisal process by reducing or eliminating the manual effort by an appraiser that otherwise would lead to a more time consuming and subjective appraisal. In particular, the automated appraisal assessment and smart electronic spreadsheet are capable of identifying suitable comparable properties for a subject property, such as by programmatically evaluating databases of property sales, services (e.g., a web service) that provide information regarding property sales, and/or website or applications that provide information regarding property sales in order to identify comparable properties that have similar property appraisal metric values as the subject property being appraised. The automated appraisal assessment and smart electronic spreadsheet are capable of evaluating the comparable properties and the subject property in order to identify any adjustments that should be made in order to compensate for any differences in property appraisal metric values. The automated appraisal assessment and smart electronic spreadsheet are capable of messaging/alerting a user, such as an appraiser, when the results of evaluating the comparable properties and/or when that data being evaluated requires additional review and/or analysis by the user.

Different formulas and/or deviation thresholds used to identify deviations between property appraisal metrics of a subject property and comparable properties may be selectively implemented and tailored for particular types of property appraisal metrics (e.g., a formula and deviation threshold may be implemented for a bathroom count property appraisal metric, while a different formula and/or deviation threshold may be implement for a square footage property appraisal metric to improve the precision of the automated appraisal assessment). This will improve the precision of assigning an appraisal value to the subject property and/or the identification of suggested adjustment values to compensate for deviations because this automated appraisal assessment takes into account such deviations on a property appraisal metric by property appraisal metric basis utilizing tailored formulas and thresholds.

Because the formulas and deviation thresholds are built into the smart electronic spreadsheet, computing resources of the computing devices can be more efficiently utilized because the already executing spreadsheet computer program can implement the formulas and deviations thresholds, as opposed to executing an additional external program or functionality, which could utilize additional computing resources. Thus, operation of the computing device is improved because resources are efficiently utilized for automated appraisal assessment. Furthermore, manual user input can be reduced because the automated appraisal assessment can automatically obtain data over a network from remote computers (e.g., obtain listing information from a listing service hosted by a remote server in order to identify suitable comparable properties) in order to automatically populate the smart electronic spreadsheet with values for property appraisal metrics, automatically apply suggested adjustment values to compensate for deviations, and/or notify an appraiser if results of analyzing the data and/or the data itself requires additional review and/or analysis by the appraiser.

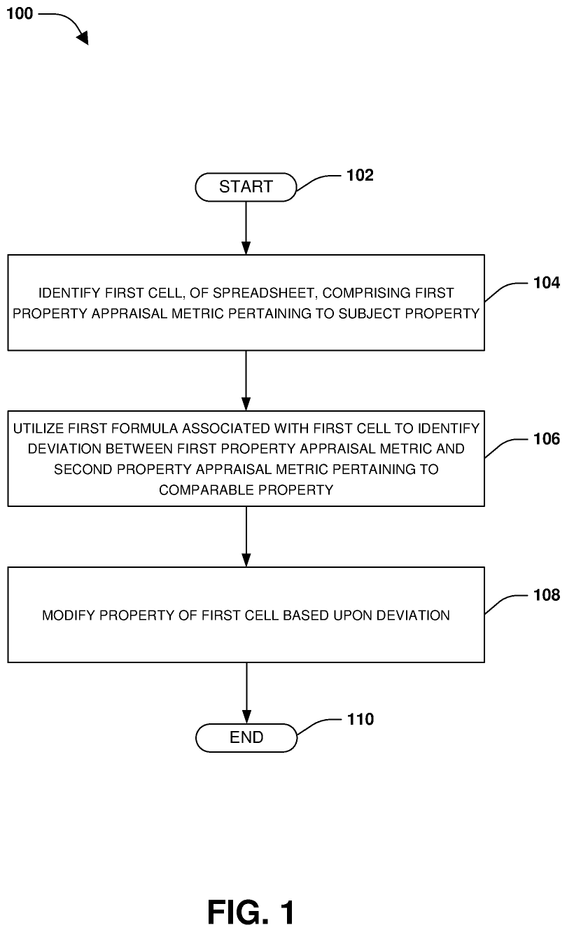

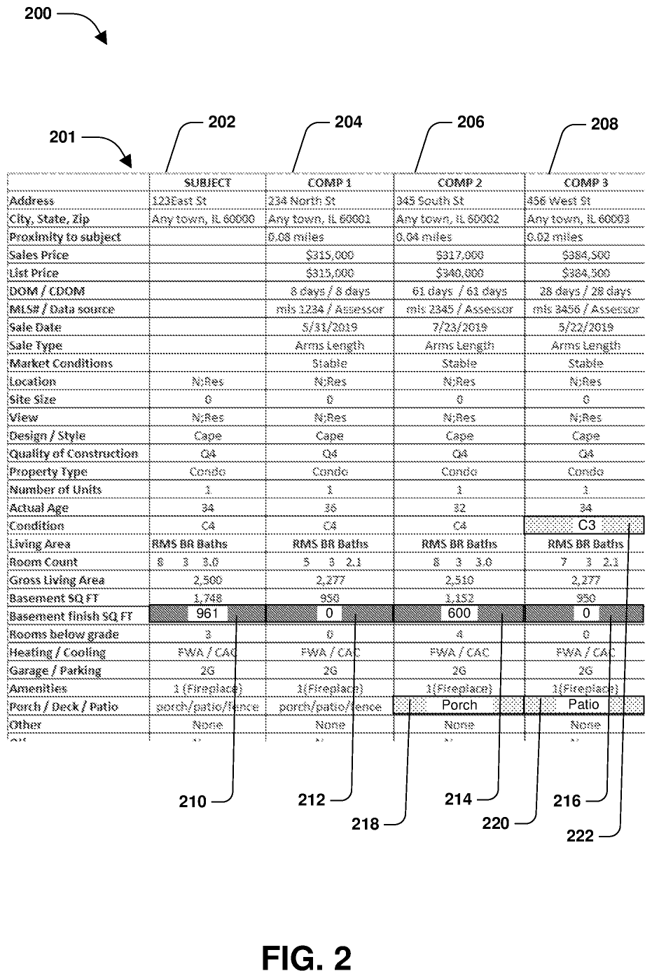

FIG. 1 illustrates a method 100 for automated appraisal assessment utilizing a spreadsheet, such as a smart electronic spreadsheet, which is further described in conjunction with the system 200 of FIG. 2. At 102, the method 100 starts. For example, the method 100 may be triggered based upon a spreadsheet computer program loading a smart electronic spreadsheet 201 for display on a computing device and/or a user invoking the automated appraisal assessment, such as through a user interface element (e.g., a button) of the spreadsheet computer program. In another example, the smart electronic spreadsheet 201 may be accessed by a web browser from a remote server at which the smart electronic spreadsheet 201 is stored. The smart electronic spreadsheet 201 may comprise information relating to a subject property 202 that is to be appraised and comparable properties, such as a first comparable property 204, a second comparable property 206, a third comparable property 208, etc. The information may comprise values for property appraisal metrics, such as an address, locational information, sale price, list price, sale date, sale type, market condition, view, design/style, quality of construction, property type (e.g., condo, house, etc.), age, condition, living area, room count, gross living area, basement square footage, basement finished square footage, rooms below grade, heating/cooling type, garage/parking, amenities, porch/deck/patio, and/or other property appraisal metrics associated with various aspects of properties. In an embodiment, the information has been populated within the smart electronic spreadsheet 201 by a user. In another embodiment, the information is automatically obtained by the spreadsheet computer program from a data source over a network, and is automatically populated within the smart electronic spreadsheet 201. In this way, the automated appraisal assessment may identify comparable properties, which are evaluated to identify adjustments to be made and/or situations when results of the evaluation and/or data being evaluated require additional review and/or analysis by an appraiser.

Each cell or groupings of cells (e.g., a grouping of cells populated with values for a same type of property appraisal metric) may be associated with a formula (e.g., the formula may be embedded into a cell or otherwise associated with the cell) and/or one or more deviation thresholds (e.g., a first deviation threshold that triggers the display of a first message or triggers a modification of a property of the cell, a second deviation threshold that triggers the display of a second message or triggers a different modification to the property of the cell, etc.). The same or different formulas and/or the same or different deviation thresholds may be associated with different cells and/or groupings of cells. The automated appraisal assessment may be invoked to evaluate property appraisal metrics within the smart electronic spreadsheet 201 utilizing the formulas and/or deviation thresholds.

At 104, a first cell 210, within the smart electronic spreadsheet 201, is identified as comprising a first property appraisal metric pertaining to the subject property 202. For example, the first cell 210 may comprise a value of 961 square feet for a basement finished square footage property appraisal metric for the subject property 202. A second cell 212, within the smart electronic spreadsheet 201, may comprise a value of 0 square feet for a basement finished square footage property appraisal metric for the first comparable property 204. A third cell 214, within the smart electronic spreadsheet 201, may comprise a value of 600 square feet for a basement finished square footage property appraisal metric for the second comparable property 206. A fourth cell 216, within the smart electronic spreadsheet 201, may comprise a value of 0 square feet for a basement finished square footage property appraisal metric for the third comparable property 208.

At 106, a first formula associated with (e.g., embedded within) the first cell 210 may be executed by the smart electronic spreadsheet 201 to compare the value of 961 square feet for the basement finished square footage property appraisal metric for the subject property 202 against the value of 0 square feet for the basement finished square footage property appraisal metric for the first comparable property 204, the value of 600 square feet for the basement finished square footage property appraisal metric for the second comparable property 206, and/or the value of 0 square feet for the basement finished square footage property appraisal metric for the third comparable property 208 utilizing one or more deviation thresholds associated with the first cell 210. In an example, the first formula may utilize a linear regression function to compare the basement finished square footage property appraisal metrics utilizing the one or more deviation thresholds. In another example, the first formula may calculate an average of the basement finished square footage property appraisal metrics for the comparable properties, which may then be compared with the basement finished square footage property appraisal metric of the subject property 202. The first formula may be executed upon the basement finished square footage property appraisal metrics to identify a deviation between the value of 961 square feet for the basement finished square footage property appraisal metric of the subject property 202 and/or the values of square footage for the basement finished square footage property appraisal metrics of the comparable properties populated within the second cell 212, the third cell 214, and/or the fourth cell 216. The first formula may be utilized to identify any adjustments that should be made to a value of the subject property 202 based upon the basement finished square footage property appraisal metric and/or if an alert should be provided to a user because the results of evaluating the data within the cells and/or the data within the cells require additional review and/or analysis by the user.

At 108, a property of the first cell 210 may be modified based upon the deviation. For example, the deviation may be based upon a difference between the basement finished square footage property appraisal metric of the subject property 202 and an average of the basement finished square footage property appraisal metrics of the comparable properties. If the deviation is below a first deviation threshold, then a background color of the first cell 210 is modified to a first color, such as green to indicate that there is a relatively low deviation. If the deviation is between the first deviation threshold and a second deviation threshold, then the background color of the first cell 210 is modified to a second color, such as yellow to indicate that there is a moderate deviation that may need to be taken into account (e.g., a +/− adjustment may need to be made to the appraisal value of the subject property into order to take into account the moderate deviation). If the deviation is greater than the second deviation threshold, then the background color of the first cell 210 is modified to a third color, such as red to indicate that there is a high deviation that should be taken into account (e.g., a +/− adjustment may need to be made to the appraisal value of the subject property into order to take into account the high deviation). It may be appreciated that any number of deviation thresholds and/or types of formulas may be utilized.

The first formula or other formulas and/or deviations thresholds associated with the second cell 212, the third cell 214, and/or the fourth cell 216 may be utilized to determine whether properties of the second cell 212, the third cell 214, and/or the fourth cell 216 should be modified. For example, a deviation between the value of 961 square feet of the basement finished square footage property appraisal metric of the subject property 202 and the value of 0 square feet of the basement finished square footage property appraisal metric of the first comparable property 204 may be used to determine whether and/or how to modify a property of the second cell 212 associated with the first comparable property 204. A deviation between the value of 961 square feet of the basement finished square footage property appraisal metric of the subject property 202 and the value of 600 square feet of the basement finished square footage property appraisal metric of the second comparable property 206 may be used to determine whether and/or how to modify a property of the third cell 214 associated with the second comparable property 206. A deviation between the value of 961 square feet of the basement finished square footage property appraisal metric of the subject property 202 and the value of 0 square feet of the basement finished square footage property appraisal metric of the third comparable property 208 may be used to determine whether and/or how to modify a property of the fourth cell 216 associated with the third comparable property 208.

Cells associated with other types of property appraisal metrics may also be evaluated by the automated appraisal assessment utilizing formulas and/or deviation thresholds associated with the cells. For example, a formula and one or more deviation thresholds associated with a fifth cell 218 may be utilized to determine whether and/or how to modify a property of the fifth cell 218 associated with the second comparable property 206. The fifth cell 218 may correspond to a porch/deck/patio property appraisal metric for the second comparable property 206, which may be compared to a porch/deck/patio property appraisal metric of the subject property 202. A formula and one or more deviation thresholds associated with a sixth cell 220 may be utilized to determine whether and/or how to modify a property of the sixth cell 220 associated with the third comparable property 208. The sixth cell 220 may correspond to a porch/deck/patio property appraisal metric for the third comparable property 208, which may be compared to a porch/deck/patio property appraisal metric of the subject property 202. A formula and one or more deviation thresholds associated with a seventh cell 222 may be utilized to determine whether and/or how to modify a property of the seventh cell 222 associated with the third comparable property 208. The seventh cell 222 may correspond to a condition property appraisal metric for the third comparable property 208, which may be compared to a condition appraisal metric of the subject property 202.

In this way, properties of cells within the smart electronic spreadsheet 201 may be dynamically modified utilizing formulas and deviation thresholds in order to highlight, flag, and/or provide indicators for property appraisal metrics that have certain levels of deviations, such as a low deviation (e.g., thus, a mere average for such property appraisal metrics of comparable properties can be taken for assigning an appraisal value to the subject property 202), high deviation (e.g., thus, manual or automated adjustment should be implemented and taken into account), etc. At 110, the method 100 ends.

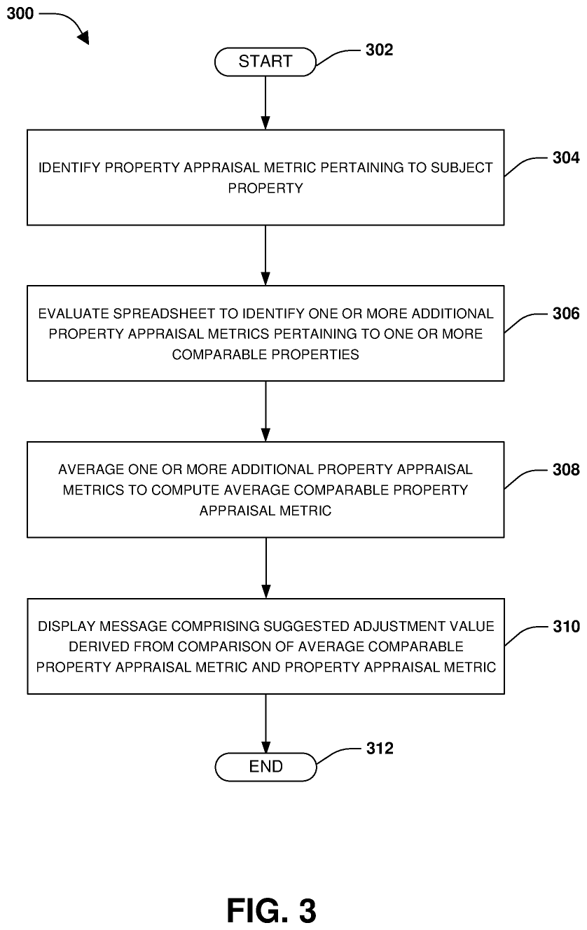

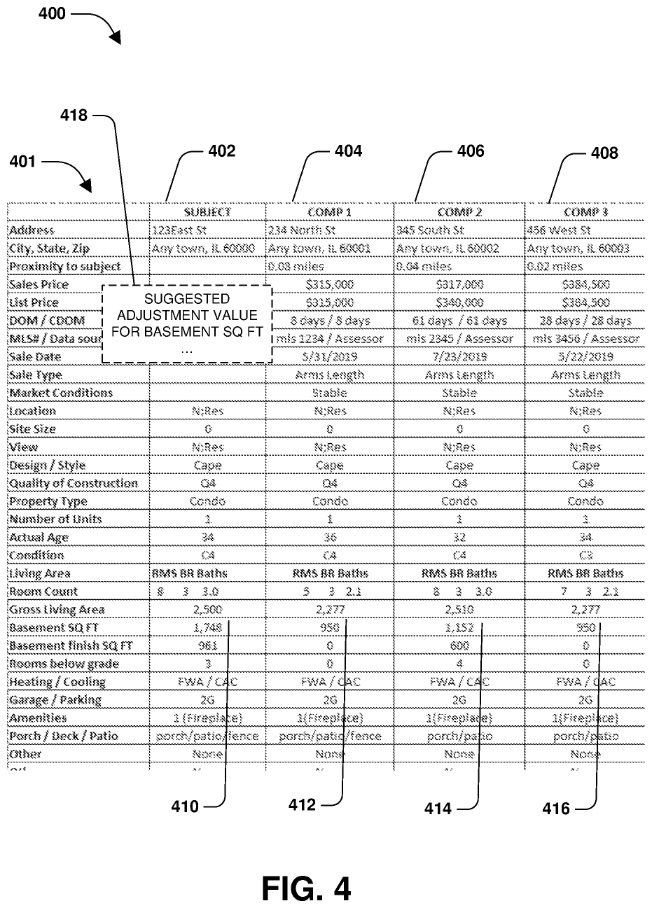

FIG. 3 illustrates a method 300 for automated appraisal assessment utilizing a spreadsheet, such as a smart electronic spreadsheet, which is further described in conjunction with the system 400 of FIG. 4. At 302, the method 300 starts. For example, the method 300 may be triggered based upon a spreadsheet computer program loading a smart electronic spreadsheet 401 for display on a computing device and/or a user invoking the automated appraisal assessment, such as through a user interface of the spreadsheet computer program. In another example, the smart electronic spreadsheet 401 may be accessed by a web browser from a remote server at which the smart electronic spreadsheet 401 is stored. The smart electronic spreadsheet 401 may comprise information relating to a subject property 402 that is to be appraised and comparable properties, such as a first comparable property 404, a second comparable property 406, a third comparable property 408, etc. The information may comprise values for property appraisal metrics, such as an address, locational information, sale price, list price, sale date, sale type, market condition, view, design/style, quality of construction, property type (e.g., condo, house, etc.), age, condition, living area, room count, gross living area, basement square footage, basement finished square footage, rooms below grade, heating/cooling type, garage/parking, amenities, porch/deck/patio, and/or other property appraisal metrics associated with various aspects of properties. In an embodiment, the information has been populated within the smart electronic spreadsheet 401 by a user. In another embodiment, the information is automatically obtained from a data source over a network, and is automatically populated within the smart electronic spreadsheet 401.

Each cell or groupings of cells (e.g., a grouping of cells populated with values for a same type of property appraisal metric) may be associated with a formula (e.g., the formula may be embedded into a cell or otherwise associated with the cell) and/or one or more deviation thresholds (e.g., a first deviation threshold that triggers the display of a first message or triggers a modification of a property of the cell, a second deviation threshold that triggers the display of a second message or triggers a different modification to the property of the cell, etc.). The same or different formulas and/or the same or different deviation thresholds may be associated with different cells and/or groupings of cells. The automated appraisal assessment may be invoked to evaluate property appraisal metrics within the smart electronic spreadsheet 401 utilizing the formulas and/or deviation thresholds.

At 304, a property appraisal metric pertaining to the subject property 402 may be identified within the smart electronic spreadsheet 401. For example, the property appraisal metric may correspond to a basement square footage property appraisal metric. A value of 1,748 square feet for the basement square footage property appraisal metric for the subject property 402 may be populated within a first cell 410 associated with the subject property 402. At 306, the smart electronic spreadsheet 401 may be evaluated to identify one or more additional property appraisal metrics pertaining to one or more comparable properties. The one or more additional property appraisal metrics may pertain to a same aspect as the property appraisal metric associated with the subject property 402. For example, one or more additional property appraisal metrics may comprise basement square footage property appraisal metrics for the first comparable property 404, the second comparable property 406, and/or the third comparable property 408. A value of 950 square feet for the basement square footage property appraisal metric for the first comparable property 404 may be populated within a second cell 412 associated with the first comparable property 404. A value of 1,152 square feet for the basement square footage property appraisal metric for the second comparable property 406 may be populated within a third cell 414 associated with the second comparable property 406. A value of 950 square feet for the basement square footage property appraisal metric for the third comparable property 408 may be populated within a fourth cell 416 associated with the third comparable property 408.

At 308, the values of the one or more additional property appraisal metrics may be averaged to compute an average comparable property appraisal metric (e.g., an average of about 1,017 square feet based upon an average of 950 square feet for the first comparable property 404, 1,152 square feet for the second comparable property 406, and 950 square feet for the third comparable property 408). The value of 1,017 square feet for the average comparable property appraisal metric, relating to the average of the basement square footage property appraisal metrics of the comparable properties, may be compared with the value of 1,748 square feet for the basement square footage property appraisal metric of the subject property 402, such as by using statistical analysis, to compute a suggested adjustment value to apply to an appraisal value for the subject property 402. The suggested adjustment value takes into account any deviation between the 1,017 square feet for the average comparable property appraisal metric of the comparable properties and the 1,748 square feet for the basement square footage property appraisal metric of the subject property 402.

At 310, a message 418 is displayed through the spreadsheet computer program based upon the comparison of the average comparable property appraisal metric of the comparable properties and the basement square footage property appraisal metric of the subject property 402. In an example, the message 418 may comprise the suggested adjustment value to apply in relation to the basement square footage property appraisal metric of the subject property 402. In another example, the message 418 may comprise an indication that a user should input a manual adjustment value in relation to the basement square footage property appraisal metric of the subject property 402. In another example, the message 418 may comprise an indication that an average (e.g., the average comparable property appraisal metric) can be utilized for taking into account the basement square footage property appraisal metric of the subject property 402. In an example, the message 418 may comprise an indication that even though there is a differential, manual adjustment is not needed due to certain calculated deviations being met (e.g., certain deviation thresholds/variances not being exceeded). In an example, the suggested adjustment value may be automatically applied to the subject property 402. In an example, the suggested adjustment value may correspond to a dollar amount to apply to the appraisal value for the subject property 402 in order to take into account a deviation between the 1,017 square feet for the average comparable property appraisal metric of the comparable properties and the 1,748 square feet for the basement square footage property appraisal metric of the subject property 402. In this way, various messages may be provided to a user, such as an appraiser, regarding how to more accurately and precisely appraise the subject property 402. At 312, the method 300 ends.

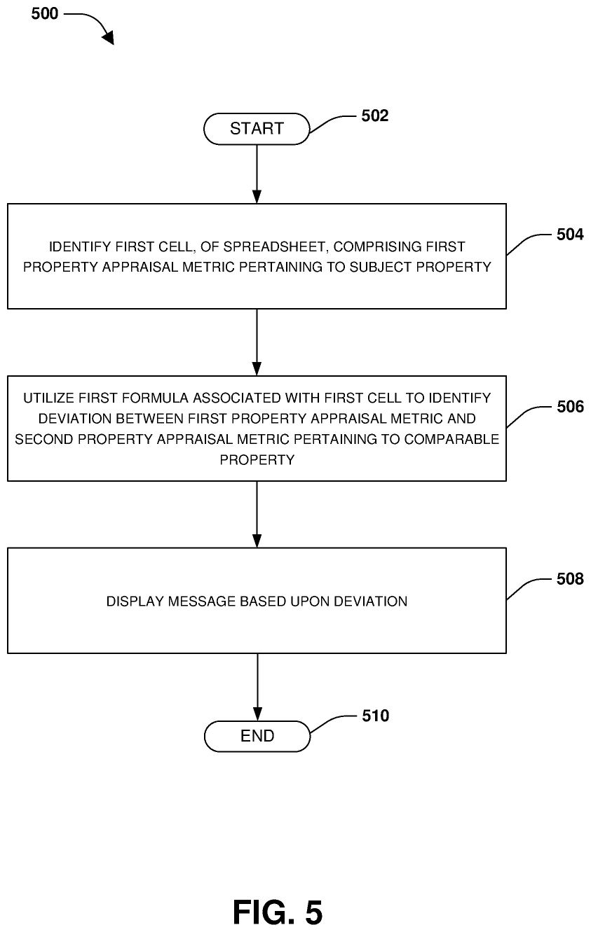

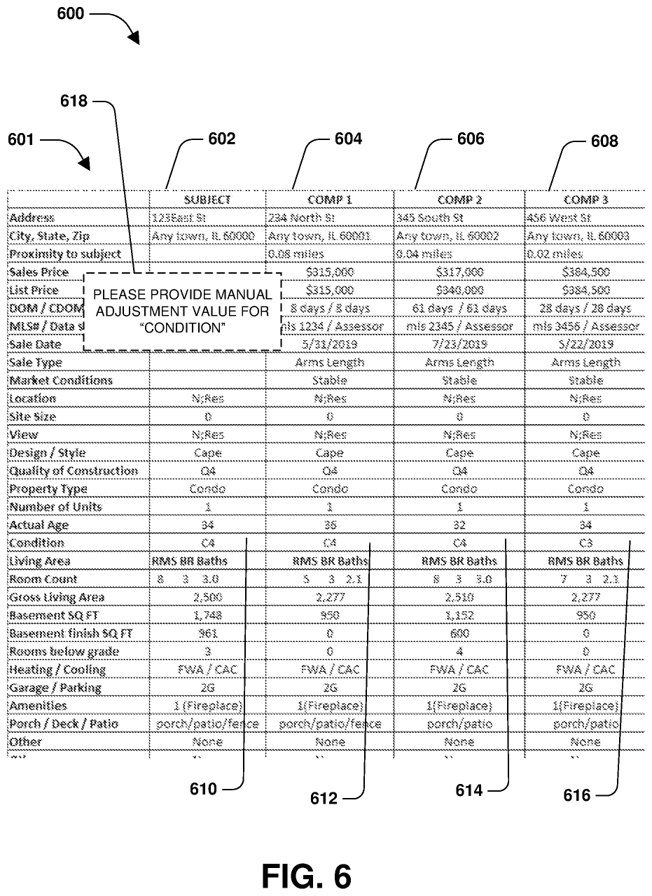

FIG. 5 illustrates a method 500 for automated appraisal assessment utilizing a spreadsheet, such as a smart electronic spreadsheet, which is further described in conjunction with the system 600 of FIG. 6. At 502, the method 500 starts. For example, the method 500 may be triggered based upon a spreadsheet computer program loading a smart electronic spreadsheet 601 for display on a computing device and/or a user invoking the automated appraisal assessment, such as through a user interface of the spreadsheet computer program. In another example, the smart electronic spreadsheet 601 may be accessed by a web browser from a remote server at which the smart electronic spreadsheet 601 is stored. The smart electronic spreadsheet 601 may comprise information relating to a subject property 602 that is to be appraised and comparable properties, such as a first comparable property 604, a second comparable property 606, a third comparable property 608, etc. The information may comprise values for property appraisal metrics, such as an address, locational information, sale price, list price, sale date, sale type, market condition, view, design/style, quality of construction, property type (e.g., condo, house, etc.), age, condition, living area, room count, gross living area, basement square footage, basement finished square footage, rooms below grade, heating/cooling type, garage/parking, amenities, porch/deck/patio, and/or other property appraisal metrics associated with various aspects of properties. In an embodiment, the information has been populated within the smart electronic spreadsheet 601 by a user. In another embodiment, the information is automatically obtained from a data source over a network, and is automatically populated within the smart electronic spreadsheet 601.

Each cell or groupings of cells (e.g., a grouping of cells populated with values for a same type of property appraisal metric) may be associated with a formula (e.g., the formula may be embedded into a cell or otherwise associated with the cell) and/or one or more deviation thresholds (e.g., a first deviation threshold that triggers the display of a first message or triggers a modification of a property of the cell, a second deviation threshold that triggers the display of a second message or triggers a different modification to the property of the cell, etc.). The same or different formulas and/or the same or different deviation thresholds may be associated with different cells and/or groupings of cells. The automated appraisal assessment may be invoked to evaluate property appraisal metrics within the smart electronic spreadsheet 601 utilizing the formulas and/or deviation thresholds.

At 504, a first cell 610, within the smart electronic spreadsheet 601, is identified as comprising a first property appraisal metric pertaining to the subject property 602. For example, the first cell 610 may comprise a value of C4 for a condition property appraisal metric for the subject property 602. A second cell 612, within the smart electronic spreadsheet 601, may comprise a value of C4 for a condition property appraisal metric for the first comparable property 604. A third cell 614, within the smart electronic spreadsheet 601, may comprise a value of C4 for a condition property appraisal metric for the second comparable property 606. A fourth cell 616, within the smart electronic spreadsheet 601, may comprise a value of C3 for a condition property appraisal metric for the third comparable property 608.

At 506, a first formula associated with (e.g., embedded within) the first cell 610 may be executed by the smart electronic spreadsheet 601 to compare the value of C4 for the condition property appraisal metric for the subject property 602 against the value of C4 for the condition property appraisal metric for the first comparable property 604, the value of C4 for the condition property appraisal metric for the second comparable property 606, and/or the value of C3 for the condition property appraisal metric for the third comparable property 608 utilizing one or more deviation thresholds associated with the first cell 610. In an example, the first formula may utilize a linear regression function to compare the condition appraisal metrics utilizing the one or more deviation thresholds. The first formula may determine that the value of C4 for the condition property appraisal metric for the subject property 602 deviates greater than a deviation threshold from the value of C3 for the condition property appraisal metric for the third comparable property 608. The first formula may be utilized to identify any adjustments that should be made to a value of the subject property 602 based upon the condition property appraisal metric and/or if an alert should be provided to a user because the results of evaluating the data within the cells and/or the data within the cells require additional review and/or analysis by the user.

At 508, a message 618 is displayed based upon the value of C4 for the condition property appraisal metric for the subject property 602 deviating greater than the deviation threshold from the value of C3 for the condition property appraisal metric for the third comparable property 608. In an example, the message 618 may comprise an instruction for a user, such as an appraiser, to perform a manual adjustment to take into account the deviation. For example, the user may increment or decrement an appraised value for the subject property 602 based upon the difference in the conditions. At 510, the method 500 ends.

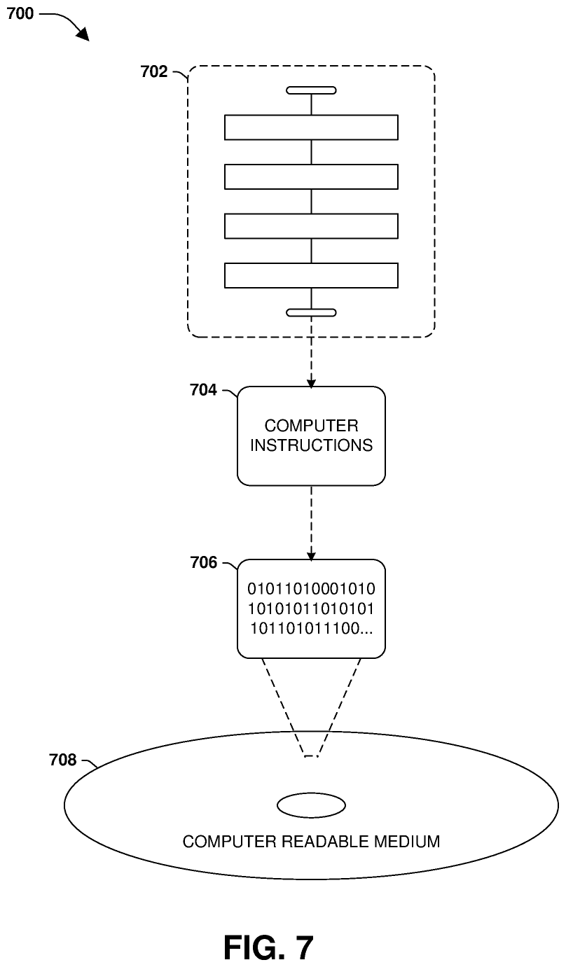

Still another embodiment involves a computer-readable medium comprising processor-executable computer instructions configured to implement one or more of the techniques presented herein. An example embodiment of a computer-readable medium or a computer-readable device is illustrated in FIG. 7, wherein the implementation 700 comprises a computer-readable medium 708, such as a CD-R, DVD-R, flash drive, a platter of a hard disk drive, etc., on which is encoded computer-readable data 706. This computer-readable data 706, such as binary data comprising at least one of a zero or a one, in turn comprises a set of processor-executable computer instructions 704 configured to operate according to one or more of the principles set forth herein. In some embodiments, the processor-executable computer instructions 704 are configured to perform a method 702, such as at least some of the method 100 of FIG. 1, at least some of the method 300 of FIG. 3, and/or at least some of the method 500 of FIG. 5, for example. In some embodiments, the processor-executable computer instructions 704 are configured to implement a system, such as at least some of the system 200 of FIG. 2, at least some of the system 400 of FIG. 4, and/or at least some of the system 600 of FIG. 6, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

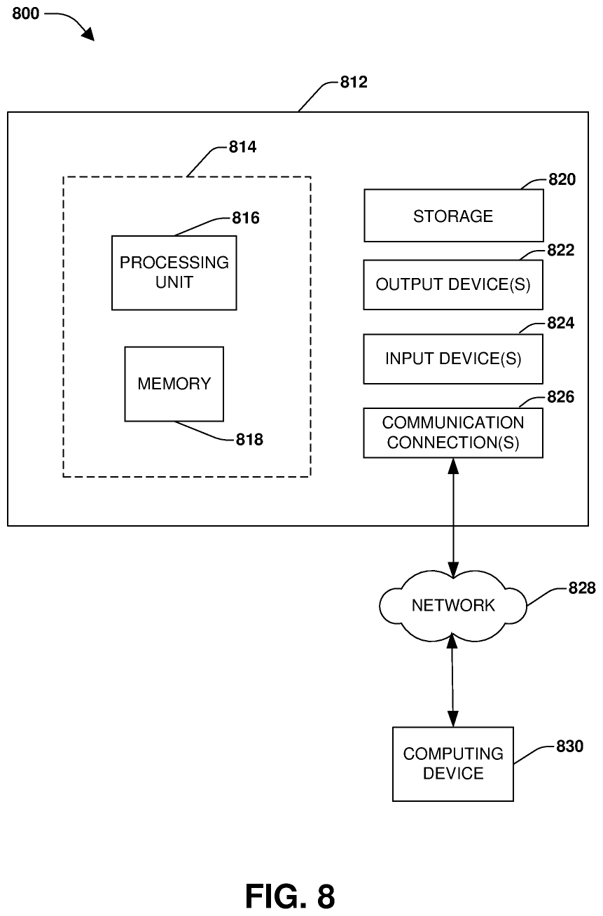

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example), or some combination of the two. This configuration is illustrated in FIG. 8 by dashed line 814.

In other embodiments, computing device 812 may include additional features and/or functionality. For example, computing device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by computing device 812. Computer storage media does not, however, include propagated signals. Rather, computer storage media excludes propagated signals. Any such computer storage media may be part of computing device 812.

Computing device 812 may also include communication connection(s) 826 that allows computing device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Computing device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in computing device 812. Input device(s) 824 and output device(s) 822 may be connected to computing device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via a network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method comprising:
identifying a first cell, of a spreadsheet, comprising a first property appraisal metric pertaining to a subject property;
utilizing a first formula associated with the first cell to compare the first property appraisal metric against a second property appraisal metric pertaining to a first comparable property to identify a deviation between the first property appraisal metric and the second property appraisal metric; and
modifying a property of the first cell based upon the deviation in response to one or more threshold deviations not being met.

2. The method of claim 1, wherein the modifying the property comprises:
applying a first color to the first cell based upon the deviation exceeding a threshold.

3. The method of claim 2, wherein the modifying the property comprises:
applying a second color to the first cell based upon the deviation being below the threshold.

4. The method of claim 1, comprising:
displaying a message based upon the deviation, wherein the message indicates that a manual adjustment value should be applied in relation to the first property appraisal metric based upon the deviation exceeding a threshold.

5. The method of claim 1, comprising:
displaying a message based upon the deviation, wherein the message indicates that an average can be utilized in relation to the first property appraisal metric based upon the deviation being below a threshold.

6. The method of claim 1, comprising:
utilizing the first formula to compare the first property appraisal metric against the second property appraisal metric and a third property appraisal metric to identify the deviation, wherein the third property appraisal metric pertains to a second comparable property.

7. The method of claim 1, wherein the second property appraisal metric is populated within a second cell of the spreadsheet.

8. The method of claim 1, comprising:
accessing a data source over a network to identify comparable properties and obtain property appraisal metrics of the comparable properties; and
automatically populating the spreadsheet with the property appraisal metrics.

9. The method of claim 1, comprising:
in response to the deviation exceeding a threshold, displaying a message based upon the deviation, wherein the message comprises a suggested adjustment value to apply to the first property appraisal metric.

10. The method of claim 1, comprising:
identifying a second cell, of the spreadsheet, comprising a third property appraisal metric pertaining to the subject property;
utilizing a second formula associated with the second cell to compare the third property appraisal metric against a fourth property appraisal metric pertaining to the first comparable property to identify a second deviation between the third property appraisal metric and the fourth property appraisal metric; and
modifying a property of the second cell based upon the second deviation.

11. The method of claim 1, wherein the first formula corresponds to linear regression functionality.

12. A non-transitory machine readable medium comprising instructions for performing a method, which when executed by a machine, causes the machine to:
identify a first cell, of a spreadsheet, comprising a first property appraisal metric pertaining to a subject property;
utilize a first formula associated with the first cell to compare the first property appraisal metric against a second property appraisal metric pertaining to a first comparable property to identify a deviation between the first property appraisal metric and the second property appraisal metric; and
display a message based upon the deviation.

13. The non-transitory machine readable medium of claim 12, wherein the instructions cause the machine to:
populate the message with an indication that a manual adjustment value should be applied in relation to the first property appraisal metric based upon the deviation exceeding a threshold.

14. The non-transitory machine readable medium of claim 12, wherein the instructions cause the machine to:
populate with message with an indication that an average can be utilized in relation to the first property appraisal metric based upon the deviation being below a threshold.

15. The non-transitory machine readable medium of claim 12, wherein the instructions cause the machine to:
in response to the deviation exceeding a threshold, populate the message with a suggested adjustment value to apply in relation to the first property appraisal metric.

16. A computing device comprising:
a memory comprising machine executable code for performing a method; and
a processor coupled to the memory, the processor configured to execute the machine executable code to cause the processor to:
identify, within a spreadsheet, a property appraisal metric pertaining to a subject property;
evaluate the spreadsheet to identify one or more additional property appraisal metrics pertaining to one or more comparable properties;
average the one or more additional property appraisal metrics to compute an average comparable property appraisal metric; and
display a message comprising a suggested adjustment value derived from a comparison of the average comparable property appraisal metric and the property appraisal metric.

17. The computing device of claim 16, wherein the machine executable code causes the processor to:
perform statistical analysis to compute the suggested adjustment value.

18. The computing device of claim 16, wherein the property appraisal metric and the one or more additional property appraisal metrics pertain to a first aspect of the subject property and the one or more comparable properties.

19. The computing device of claim 16, wherein the machine executable code causes the processor to:
automatically apply the suggested adjustment value to the subject property.

20. The computing device of claim 16, wherein the suggested adjustment value corresponds to an appraised value of the subject property.
